(19) United States
(12) Patent Application Publication
(10) Pub. No.: US 2016/0151935 A1
(43) Pub. Date: Jun. 2, 2016

(54) CO-INJECTION METHOD, PREFORM, AND CONTAINER

(71) Applicant: PLASTIPAK PACKAGING, INC., Plymouth, MI (US)

(72) Inventor: Thomas J. SIMPSON, Marshallville, OH (US)

(21) Appl. No.: 14/904,189

(22) PCT Filed: Jul. 14, 2014
(86) PCT No.: PCT/US2014/046475

§ 371 Date: Jan. 11, 2016

Related U.S. Application Data
(60) Provisional application No. 61/845,730, filed on Jul. 12, 2013.

(51) Int. Cl. B29B 11/08; B29C 45/77; B29C 45/16

(52) U.S. Cl. CPC B29B 11/08; B29C 45/1646; B29C 45/77; B29C 2945/76595; B29C 2945/76745; B29C 2945/76859; B29K 2067/003

(57) ABSTRACT

A method of forming a multi-layer, co-injection molded article is disclosed. In an embodiment inner, middle, and outer layers of a polymer material are co-injected, and the velocity of the co-injection of the inner, middle, and outer layers are controlled. In embodiments of the method, the velocity of the co-injecting is less than about 0.390 inch/second. With embodiments, the articles may be formed from polyethylene terephthalate (PET). Articles, such as preforms, that are formed from a co-injection process, in which velocity is controlled, are also disclosed.

### CROSS-REFERENCE TO RELATED APPLICATIONS

This application is a national stage filing based upon International PCT Application No. PCT/US2014/046475, with an international filing date of Jul. 14, 2014, which claims the benefit of priority to U.S. Provisional Application No. 61/845,730, filed Jul. 12, 2013, the entire disclosures being incorporated herein by reference.

### TECHNICAL FIELD

The present invention relates generally to plastic preforms and containers formed utilizing co-injection molding apparatus, systems, and methods.

### BACKGROUND

Conventional co-injection molding apparatus and systems can be configured to provide a plurality of sequential or simultaneous streams of moldable plastic material to mold cavities to produce multi-layer co-injected articles. Some known systems, such as systems disclosed in connection with U.S. patent application Ser. No. 13/238,074, provide co-injection injection molding systems with hot runners to control the flow of multiple melt streams through a mold gate and into a mold cavity. However, such conventional co-injection systems may be primarily pressure-based, which may not be consistent with producing articles comprised of certain polymeric materials, such as polyethylene terephthalate (PET). Consequently, such conventional systems have been used to form closures or caps, but generally have not found success forming more complex structures such as preforms or containers (e.g., bottles).

As such, there is a challenge and desire in the industry to provide multi-layered, co-injection apparatus, systems, and articles, including preforms and containers with certain properties or characteristics. Moreover, as noted, there can be certain challenges in providing such articles comprised of certain polymers, such as PET.

### SUMMARY

A method of forming a multi-layer, co-injection molded article is disclosed. In an embodiment inner, middle, and outer layers of a polymer material are co-injected, and the velocity of the co-injection of the inner, middle, and outer layers are controlled. In some embodiments of the method, the articles are formed from polyethylene terephthalate (PET). Articles, such as preforms, that are formed from a co-injection process, in which velocity is controlled, are also disclosed.

### BRIEF DESCRIPTION OF THE DRAWINGS

Embodiments of the invention will now be described, by way of example, with reference to the accompanying drawings, wherein:

FIG. 1 is a graph of a co-injection molding machine cycle according to aspects of the disclosure;

FIG. 2 is a side elevation view of an embodiment of a preform generally illustrating aspects of the disclosure;

FIG. 3 is top view of the embodiment of a preform shown in FIG. 2;

FIG. 4 is cross-sectional view of the embodiment of a preform shown in FIG. 2;

FIG. 5 is a perspective view of an embodiment of a container generally illustrating aspects of the disclosure;

FIG. 6 is bottom view of the embodiment of a container shown in FIG. 5;

FIG. 7 is side elevation view of the embodiment of a container shown in FIG. 5; and

FIG. 8 is a cross sectional view of a portion of a container.

### DETAILED DESCRIPTION

Reference will now be made in further detail to embodiments of the present disclosure, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the concept as disclosed herein.

The present disclosure includes embodiments that may be directed to preforms and/or containers that are suitable for products such as milk and beer. Such preforms and/or container may, if desired, include one or more barrier layers that extend for varying vertical lengths with respect to such articles. For example and without limitation, such barrier layers may be comprised of various known barrier materials used with bottles and containers.

As previously noted, conventional systems for co-injection molding exist. Such systems include processing software and controls that can be said to be primarily pressure-based (for example, applying and controlling pressures in the nature of about 8500 psi to 9000 psi). An example of such a process is disclosed in connection with U.S. patent application Ser. No. 13/238,074. However, pressures associated with conventional co-injection molding machines (particularly those intended to form preforms for containers or bottles) may not be consistent with running certain polymeric materials, such as PET (which can require comparatively higher temperatures and can be more difficult to run). With embodiments of the disclosed system, instead of using (or primarily relying upon) pressure and pressure control, the system can be configured to control velocity (or speed). Moreover, with embodiments of the disclosed system, the use of velocity can provide total or near total control with the co-injection process.

With embodiments, settings of a co-injection apparatus or system may be intentionally modified from conventional minimum velocity/valve gate tolerances. For example, without limitation, a minimum velocity tolerance may be modified from a conventional velocity setting of about 0.5 inch/second to a much slower, and conventionally-novel, speed that may be down to as low as about 0.01 inch/second, or less. Notably, with presently available conventional co-injection molding systems, at least with certain materials, the associated multi-controller generally does not permit an injection speed slower than 0.390 inch/second. In fact, with some commercial units, the controller will actually override slower speeds if such an entry is attempted. The present concept contemplates speeds that are below conventional speeds, may be less than about 0.250 inch/second, may be less than 0.05 inch/second, and, for some embodiments, may be less than 0.01 inch/second, far slower than systems that are conventionally available contemplate.

Moreover, with embodiments, valve gate logic may be a significant control parameter, and may be modified in accordance with teachings of the present disclosure. For example, with certain embodiments having actuation timing at the beginning of opening a melt channel, the co-injection associated with the channel will already be in process prior to opening.

Additionally, with some custom preform and layer control, several combinations/customizations may be made. With conventional systems, tooling changes are commonly required—such as employing custom nozzles. The present disclosure may avoid a tooling change by employing a valve gate. The use of a valve gate in accordance to the teachings of the present disclosure may allow for the provision of different thickness ratios with each layer without necessitating a tooling change. In contrast, with current systems volumetric displacement is generally used to control each layers thickness.

With embodiments, the thickness (at a vertical position) of each co-extruded layer of an article (such as a preform), may be varied along the vertical length of the article. Moreover, given the control associated with the process, the thickness of the inner and outer layers of an article may be different, and may differ along all or portions of their respective vertical lengths.

With embodiments of the present disclosure, it is possible to increase or decrease the inner layer thickness by controlling the extent to which a valve gate is opened. For example only, and without limitation, a valve gate may be provided that opens to a maximum diameter of about 10 mm. Opening to, for instance, the first 3 mm of the maximum diameter may provide an outer layer. At a 7 mm opening, the middle layer may be said to be formed. And an inner layer may be said to be formed at or about a valve opening of 9 mm. With such an exemplary embodiment, if it is desirable to provide a thinner inner layer, the valve gate may, for example, be opened at less than a 9 mm opening.

With various embodiments, a preform may be formed in which a middle layer is provided at several vertical positions below a support ring. In an embodiment, the middle layer—viewed vertically at a given vertical position—may have a thickness that is, for example, between about 4% and about 11% of the total wall thickness. With such a preform, the outer layer may have a greater thickness than the inner layer at each vertical position.

With other embodiments, a preform may be formed in which the a middle layer is also provided at several vertical positions below a support ring. In an embodiment, the middle layer—viewed vertically at a given vertical position—may have a thickness that is, for example, between about 9% and about 16% of the total wall thickness. With such a preform, the outer layer may have a greater thickness than the inner layer at each vertical position.

Moreover, the present disclosure can provide articles (e.g., preforms or containers) in which certain layers, such as a middle layer (which for some embodiments may be one of a plurality of middle layers), may be limited to certain vertical portions of the article. For example, and without limitation, some or all of the body portion of a container may include a middle layer (which may provide some desirable properties), while the base and/or neck portion of the same container may include just a portion of such a middle layer, or even no middle layer at all, extending into one or both of those portions.

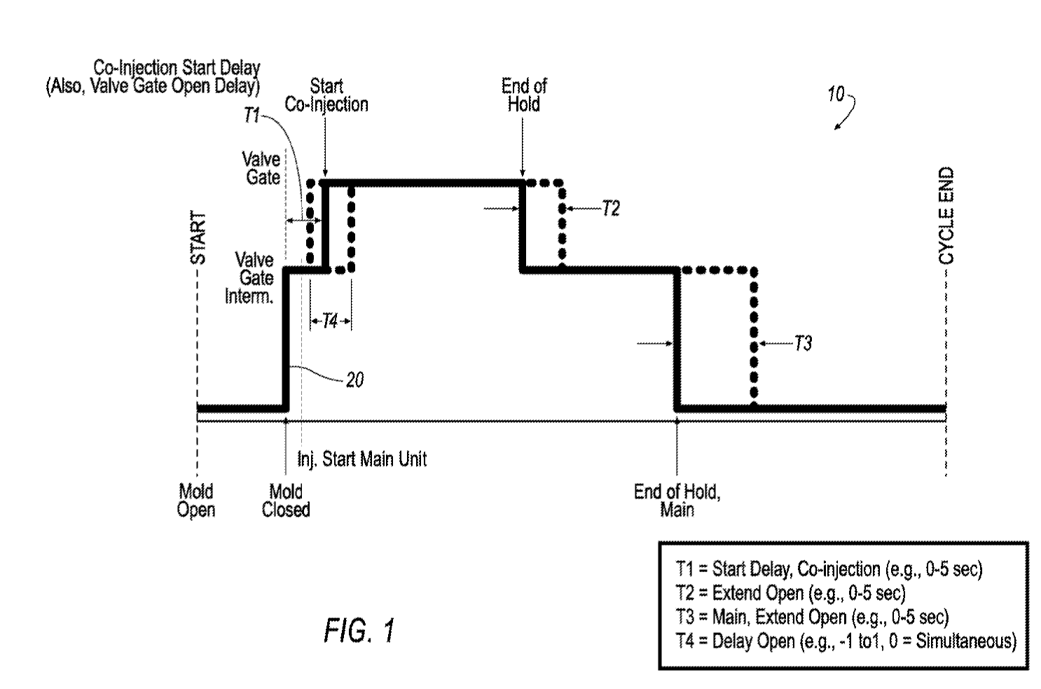

With embodiments of the present disclosure, timing can be a significant parameter. Without limitation, an embodiment of an exemplary machine cycle 10 is generally illustrated in graph form in FIG. 1. The primary line 20 depicted in FIG. 1 generally indicates valve gate position.

The start of injection (or start of co-injection) can be triggered by a number of items or events that are consistent with an injection molding machine cycle. For example, a “mold closed” command may be used as a trigger. As generally illustrated, T1 may comprise a “start delay.” When a timer times out, the injection unit may start injection, and the valve gate may be open to the full open position at the same time—i.e., unless there is a value other than 0.0 associated with T4.

For example, if T4 is positive number (e.g., 1.0), the valve gate may be configured to open at some point in time (e.g., 1 second) after injection start. Conversely, if T4 is a negative number (e.g., −1 second), then the valve gate may “pre-open” for that amount of time. The valve gate may be configured to automatically close to an intermediate position at the end of a hold time—that is, unless there is a value on T2 that would delay the closing to an intermediate position.

With embodiments, the valve gate may be fully closed at the end of a “Hold” designation on a main unit—unless there is a value on T3. Where there is no signal with a system (such as an EU67 signal) for end of injection, one may be provided.

For embodiments, the timing—including coordination and/or synchronization—of the valve gate with the injection/co-injection start and end can be significant. The coordination of timing can help ensure that process changes to not unduly affect that relationship. With some embodiments, making a change to the injection fill time, hold time, or other time may be compensated with a valve gate adjustment. It is noted that valve gate timing and injection start can be significant parameters for limiting/preventing back-flow and mixing. For some embodiments, to help maintain the process, the valve gate timing may be directly linked or synchronized to injection function.

Embodiment of the disclosed apparatus/system may provide co-injection molded articles, such as preforms and containers, that have various desirable features and/or properties. For example, among other things, co-injection molded, multi-layer, PET articles may be provided that are suitable for a number of applications, including some applications that may be considered “specialized” (such as applications for use in the dairy and/or beer markets).

Without limitation, in embodiments a preform may be provided that is comprised of at least three co-injected layers. In an embodiment, a white inner and outer layer may be formed around a middle layer. It is noted that some embodiments may include a plurality of “middle” layers provided between an inner and outer layer. Such a middle layer may, for example, comprise a carbon layer that may, for instance, provide a measure of ultraviolet (UV) protection to the intended contents of an eventually-formed (e.g., blow molded) container—such as one suitable for milk. An embodiment of such a preform may weigh, for example, about 24 grams, with the middle layer comprising about 8 grams of the total weight. In an embodiment, a middle layer may include a resin mixture comprising approximately 15% carbon black, 4% PET (white), and a remainder (about 81%) of standard PET (for e.g., PET made commercially available under the trade name Clearturf™ Turbo II provided by M&G Chemical). In embodiments, such middle layer may be controllably formed to (a) be extremely thin (for example, about 3% or less of the total preform/container thickness) and/or (b) to extend along select vertical portions of the preform/container. For instance, a preform may be provided in which the middle layer extends along the portion of the preform that is intended to be formed into the body (or sidewall) portion of a container, but is generally (or even entirely) missing from inclusion in the portions of the preform that form the neck and/or base portion of the intended resulting container.

In an alternate embodiment, such as for a container intended to hold beer, a preform may be provided in which the inner and outer layers are comprised of a clear PET material. A middle layer provided between the inner and outer layers may be comprised of an oxygen scavenging material. Examples of oxygen scavenging materials may include, without limitation, active scavengers (e.g., Amosorb™ from ColorMatrix, OxyClear™ from Invista, and Valor™ from Valspar), passive scavengers (e.g., Poliprotect™ from M&G Chemicals, Polyshield™ from Invista, DiamondClear™ from Constar, and SolO2™ from ColorMatrix), catalytic scavengers (e.g. HyGuard™ from ColorMatrix), and variations of the foregoing, which may include without limitation the addition of nylon, carbon, silica, cobalt salt, or other additives to plastic resin.

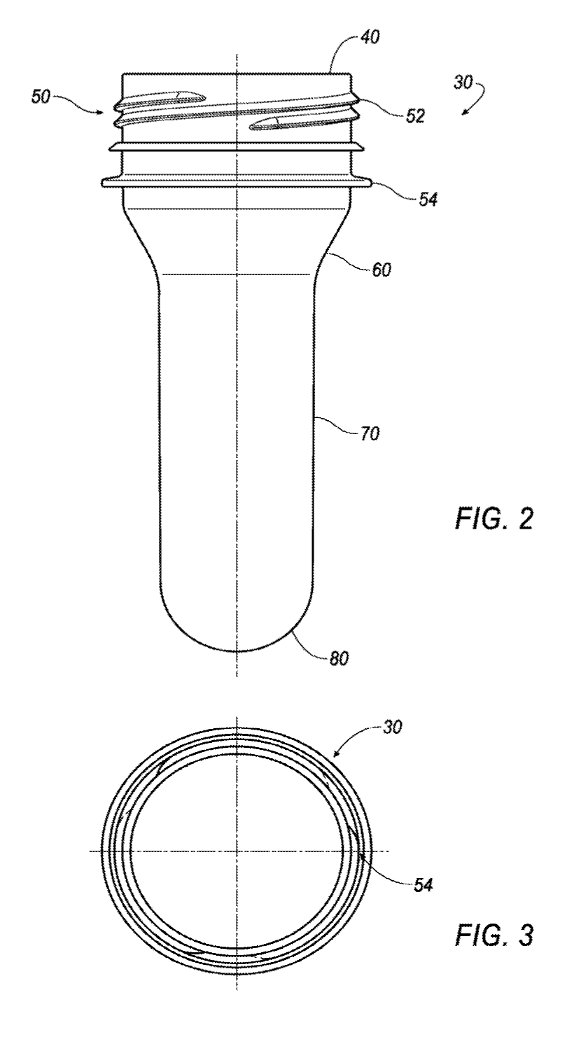

By way of example, and without limitation, examples of an embodiment of a preform and a container produced in accordance with teaching of the present disclosure are generally illustrated in FIGS. 2-8.

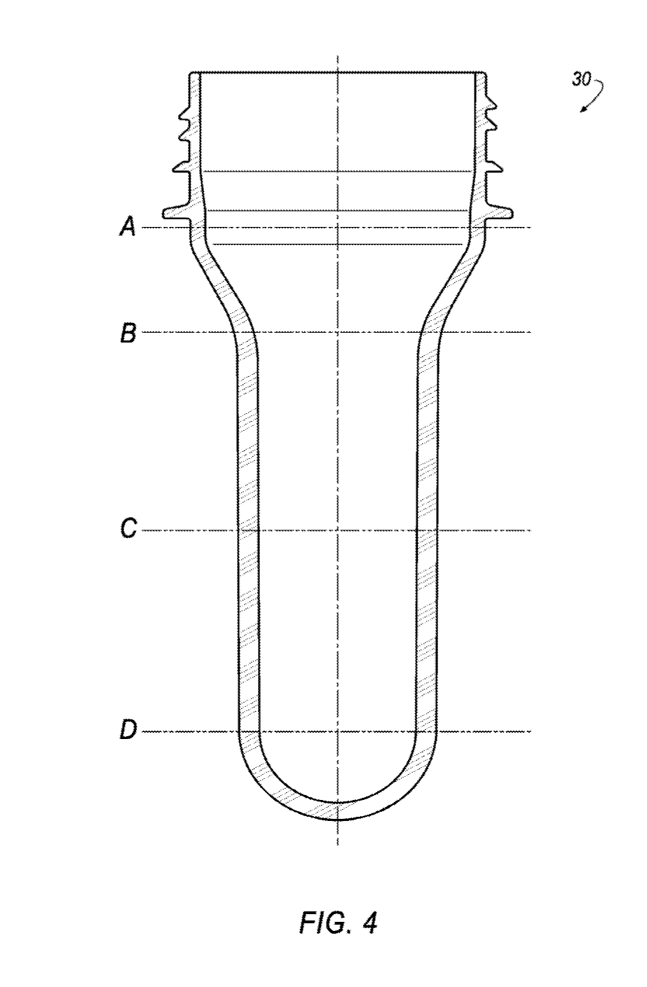

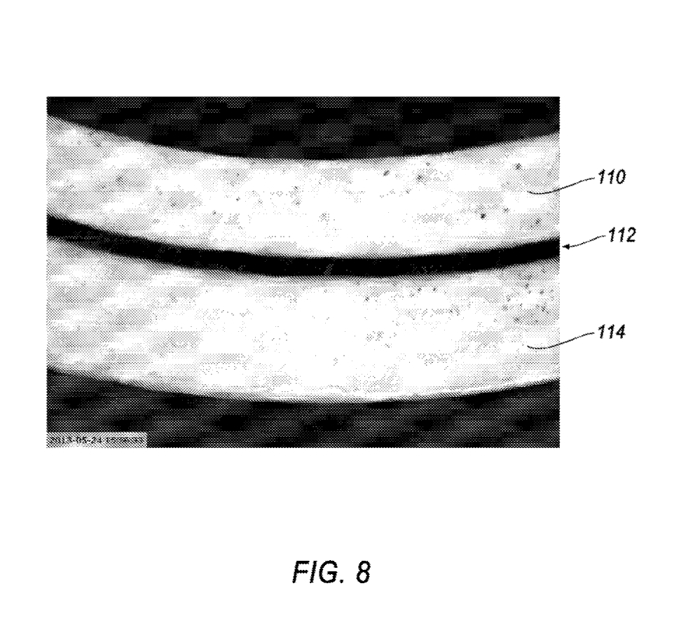

A side view of an embodiment of a preform 30 is generally illustrated in FIG. 2. The preform 30 may include, for example, an opening 40, a neck portion 50 with threads 52 and a support flange 54, a tapered portion 60, a sidewall 70, and a closed bottom portion 80. A top view of the preform 30 is shown in FIG. 3. In FIG. 3, a thread start is generally indicated at 54. FIG. 4 illustrated a cross-sectional view of the embodiment of a preform shown in FIG. 2. While the cross section of the preform 30 is shown as having a single layer (which may have different thicknesses in different portions), it is noted that the thickness of the preform in cross section may actually be comprised of a plurality of layers. For example and without limitation, the preform may comprise inner, middle, and outer layers, such as such layering is generally disclosed herein. That is, in a preform, and hence a resultant container formed from such a preform, at least the majority of the walls of the preform/container—viewed in cross-section—may be multi-layered. FIG. 8 generally illustrates the concept with a cross sectional view of a portion of a container with an inner layer 110, a middle layer 112, and an outer layer 114.

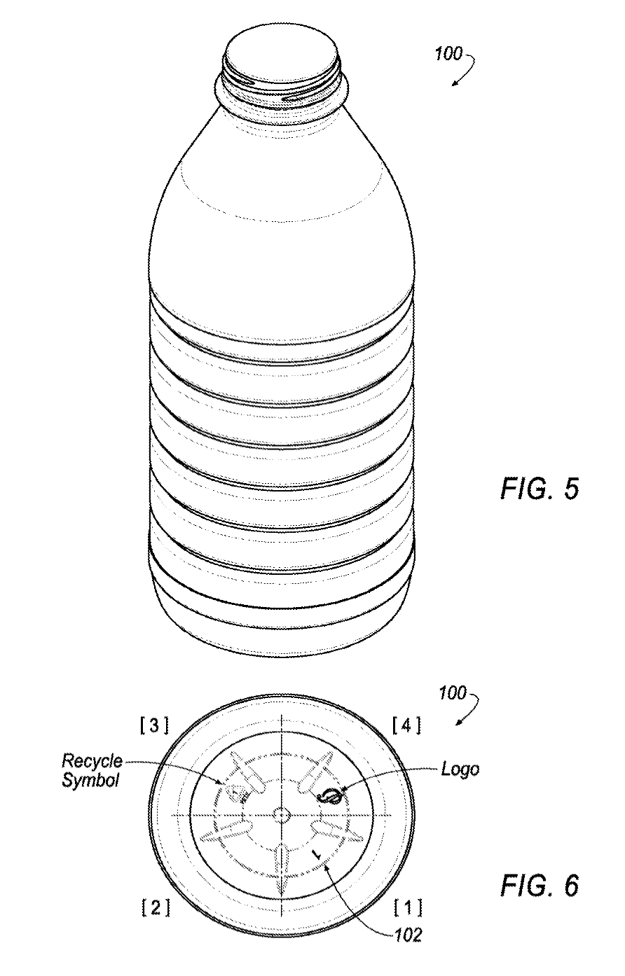

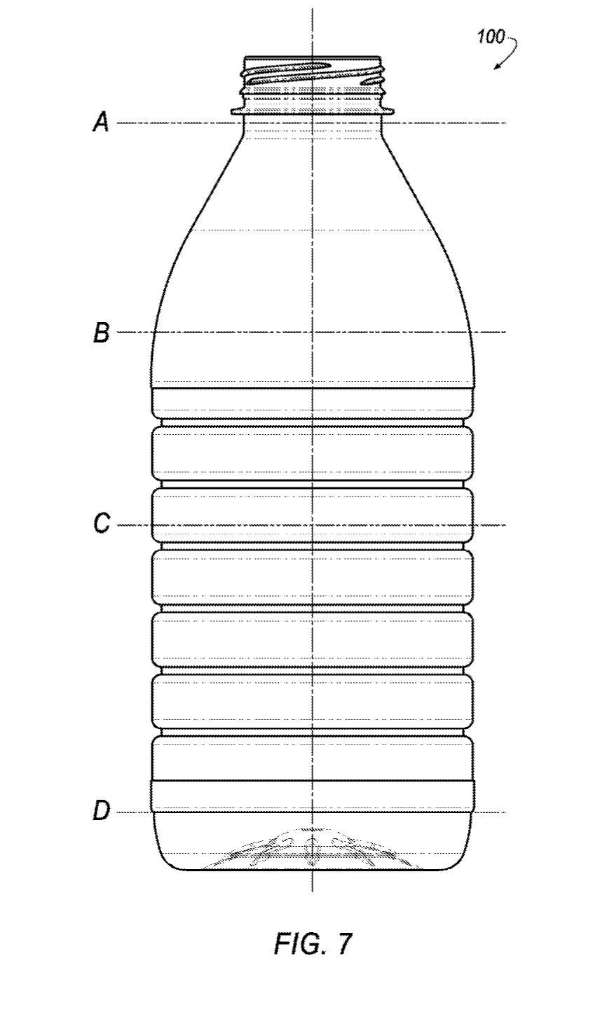

FIG. 5 generally illustrates a perspective view of an embodiment of a container 100 that may be formed from a preform. The container 100 is not limited to the shape, size, and construction shown, and may be provided in many other forms. For reference, a bottom view of the embodiment of a container shown in FIG. 5 is shown in FIG. 6. With reference to that view, four points designated [1] through [4] are generally illustrated. For purposes of reference, Point [1] may be said to generally line up with the mold cavity number 102, and the other points (Points [2], [3], and [4]) in sequence may be 90 degrees apart, moving in a clockwise direction. For later reference, four similar points in a circular context (and spaced 90-degrees apart) may be generally designated in connection with the preform illustrated in FIGS. 2-4. FIG. 7 is side elevation view of the container illustrated in FIG. 5.

For example and without limitation, embodiments of a preform 30 and a container 100 are generally shown in FIGS. 4 and 7. With both the illustrated preform 30 and container 100, various vertical locations/positions are generally indicated by the letters A, B, C, and D. For reference and without limitation, location/position A may be said to be provided below a support ring; location/position B may be said to be provided in the “upper body”; location/position C may be said to be provided in the “middle body”; and location/position D may be said to be provided in the “lower body.”

With reference to the foregoing disclosure and convention, and without limitation, the following table sets for data associated with an embodiment of a preform:

| | | Thickness | | | % | | | Average % for that height | | |
|---|---|---|---|---|---|---|---|---|---|---|
| Height | Point | Outer | Middle | Inner | Outer | Middle | Inner | Outer | Middle | Inner |
| Below | 1 | 0.055 | 0.013 | 0.043 | 49.5% | 12.0% | 38.6% | 50.3% | 11.1% | 38.6% |
| support | 2 | 0.051 | 0.012 | 0.051 | 44.7% | 10.7% | 44.7% | | | |
| ring | 3 | 0.063 | 0.010 | 0.037 | 56.7% | 9.4% | 33.9% | | | |
| | 4 | 0.057 | 0.014 | 0.042 | 50.5% | 12.4% | 37.1% | | | |
| Upper | 1 | 0.060 | 0.010 | 0.045 | 51.8% | 8.8% | 39.3% | 52.0% | 9.2% | 38.8% |
| body | 2 | 0.061 | 0.010 | 0.046 | 51.9% | 8.8% | 39.3% | | | |
| | 3 | 0.056 | 0.010 | 0.049 | 49.0% | 8.6% | 42.4% | | | |
| | 4 | 0.063 | 0.012 | 0.039 | 55.3% | 10.7% | 34.1% | | | |
| Middle | 1 | 0.065 | 0.004 | 0.047 | 56.3% | 3.1% | 40.6% | 53.5% | 4.6% | 41.9% |
| Body | 2 | 0.054 | 0.005 | 0.059 | 45.7% | 4.0% | 50.4% | | | |
| | 3 | 0.058 | 0.005 | 0.041 | 55.7% | 4.8% | 39.6% | | | |
| | 4 | 0.067 | 0.008 | 0.045 | 56.3% | 6.4% | 37.3% | | | |
| Lower | 1 | 0.062 | 0.004 | 0.044 | 56.4% | 3.3% | 40.2% | 52.7% | 4.3% | 43.0% |
| Body | 2 | 0.051 | 0.004 | 0.058 | 44.8% | 3.8% | 51.4% | | | |
| | 3 | 0.059 | 0.005 | 0.048 | 53.0% | 4.3% | 42.8% | | | |
| | 4 | 0.071 | 0.008 | 0.047 | 56.5% | 6.0% | 37.4% | | | |

Similarly, with reference to the foregoing disclosure and convention, and without limitation, the following table sets for data associated with an embodiment of a container that may be formed from the preform:

| | | Thickness | | | % | | | Average % for that height | | |
|---|---|---|---|---|---|---|---|---|---|---|
| Height | Point | Outer | Middle | Inner | Outer | Middle | Inner | Outer | Middle | Inner |
| Below | 1 | 0.009 | 0.003 | 0.010 | 42.2% | 12.6% | 45.2% | 46.0% | 13.1% | 40.9% |
| support | 2 | 0.009 | 0.003 | 0.009 | 45.0% | 12.5% | 42.6% | | | |
| ring | 3 | 0.008 | 0.002 | 0.007 | 48.1% | 14.0% | 38.0% | | | |
| | 4 | 0.009 | 0.003 | 0.007 | 48.8% | 13.4% | 37.8% | | | |
| Upper | 1 | 0.005 | 0.001 | 0.005 | 43.6% | 11.8% | 44.5% | 51.5% | 10.3% | 38.2% |
| body | 2 | 0.005 | 0.001 | 0.003 | 55.7% | 11.5% | 32.8% | | | |
| | 3 | 0.005 | 0.001 | 0.005 | 44.9% | 8.9% | 46.2% | | | |
| | 4 | 0.007 | 0.001 | 0.003 | 61.8% | 9.0% | 29.2% | | | |
| Middle | 1 | 0.004 | 0.001 | 0.004 | 46.4% | 12.0% | 41.7% | 52.8% | 9.9% | 37.3% |
| Body | 2 | 0.005 | 0.001 | 0.005 | 46.8% | 9.8% | 43.4% | | | |
| | 3 | 0.007 | 0.001 | 0.004 | 58.3% | 9.0% | 32.7% | | | |
| | 4 | 0.006 | 0.001 | 0.003 | 59.9% | 8.7% | 31.4% | | | |
| Lower | 1 | 0.004 | 0.001 | 0.003 | 51.4% | 12.6% | 36.0% | 53.4% | 16.3% | 30.4% |
| Body | 2 | 0.005 | 0.002 | 0.002 | 57.0% | 19.4% | 23.6% | | | |
| | 3 | 0.004 | 0.001 | 0.002 | 54.1% | 18.0% | 28.0% | | | |
| | 4 | 0.004 | 0.001 | 0.003 | 51.0% | 15.1% | 33.9% | | | |

Among other things, the foregoing tables (which includes thickness measurements in inches) generally illustrate, how the thicknesses of the outer, middle, and inner layers may vary—with respect to individual layers and/or in comparison to each other—at different vertical portions of a preform and resultant container.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims appended hereto and their equivalents.

What is claimed is:

1. A method for forming a co-injection molded article, the method comprising:
co-injecting at least an inner layer and an outer layer of a polymer material; and
controlling the velocity of the co-injecting of the inner layer and the outer layer, wherein the velocity of the co-injecting is less than about 0.390 inch/second.

2. The method of claim 1, wherein the velocity is less than about 0.250 inch/second.

3. The method of claim 1, wherein the velocity is less than about 0.05 inch/second.

4. The method of claim 1, wherein the velocity is less than about 0.01 inch/second.

5. The method of claim 1, wherein a valve gate controls the velocity of the co-injecting.

6. The method of claim 1, wherein a valve gate is controllably opened to different diameters.

7. The method of claim 1, wherein a valve gate is controllably opened to at least three different diameters, and is configured to form different layers of the molded article.

8. The method of claim 1, wherein a valve gate controls the thickness ratios with respect to each layer.

9. The method of claim 1, wherein an actuation timing is employed at the beginning of opening a melt channel, and co-injecting commences prior to opening the melt channel.

10. The method of claim 1, wherein the start of cycle timing is triggered by one or more triggering events involved with an injection molding machine cycle.

11. The method of claim 10, wherein a “mold closed” command is a triggering event.

12. The method of claim 1, wherein when a timer times out, the co-injecting commences.

13. The method of claim 1, wherein a valve gate is opened to the full position at the same time co-injecting commences.

14. The method of claim 1, wherein a valve gate is “pre-open” prior to co-injecting.

15. The method of claim 1, wherein a valve gate is linked to or synchronized with the co-injecting.

16. The method of claim 1, including co-injecting a middle layer between at least a portion of the inner layer and at least a portion of the outer layer.

17. The method of claim 16, wherein the middle layer is provided below a support ring of the molded article.

18. The method of claim 16, wherein, when viewed at a given vertical position in a sidewall, the thickness of the middle layer is between about 4% and about 11% of the total wall thickness.

19. The method of claim 16, wherein, when viewed at a given vertical position in a sidewall, the thickness of the middle layer is between about 9% and about 16% of the total wall thickness.

20. The method of claim 1, wherein, when viewed at a given vertical position, the outer layer has a greater thickness than the inner layer.

21. The method of claim 1, wherein the article is a preform.

22. The method of claim 1, wherein the polymer material comprises polyethylene terephthalate (PET).

23. The method of claim 1, wherein the thickness of the inner layer and outer layer are independently varied along a vertical length of the article.

24. The method of claim 1, including co-injecting a middle layer between at least a portion of the inner layer and at least a portion of the outer layer, and wherein the thickness of at least one of the inner layer, the middle layer, and the outer layer is independently varied along a vertical length of the article.

25. The method of claim 1, wherein the inner layer and the outer layer have different thicknesses at the same vertical position.
